(19) United States
(12) Patent Application Publication
(10) Pub. No.: US 2025/0096274 A1
(43) Pub. Date: Mar. 20, 2025

(54) LITHIUM METAL SECONDARY BATTERY

(71) Applicant: TOYOTA JIDOSHA KABUSHIKI KAISHA, Toyota-shi Aichi-ken (JP)

(72) Inventors: Ryo Asakura, Sunto-gun Shizuoka-ken (JP); Shinya Shiotani, Nagoya-shi Aichi-ken (JP); Sakina Kaneko, Fujisawa-shi Kanagawa-ken (JP)

(73) Assignee: TOYOTA JIDOSHA KABUSHIKI KAISHA, Toyota-shi Aichi-ken (JP)

(21) Appl. No.: 18/830,142

(22) Filed: Sep. 10, 2024

(30) Foreign Application Priority Data
Sep. 14, 2023 (JP) 2023-149324

(51) Int. Cl. H01M 4/62; H01M 4/02; H01M 4/36

(52) U.S. Cl. CPC H01M 4/628; H01M 4/366; H01M 2004/027

(57) ABSTRACT

It is an object of the present disclosure to provide a lithium metal secondary battery capable of improving cycle property. A lithium metal secondary battery, wherein the lithium metal secondary battery comprises a negative electrode current collector layer, an alloy layer, an electrolyte layer, a positive electrode active material layer, and a positive electrode current collector layer in this order, and wherein the alloy layer comprises an alloy having indium and tin.

### CROSS-REFERENCE TO RELATED APPLICATIONS

This application claims priority to Japanese Patent Application No. 2023-149324 filed Sep. 14, 2023, the entire contents of which are herein incorporated by reference.

### FIELD

The present disclosure relates to a lithium metal secondary battery.

### BACKGROUND

In a lithium metal secondary battery using metal lithium as a negative electrode active material, lithium metal is deposited and dissolved on the negative electrode side by charging and discharging (oxidation-reduction reaction). Since lithium metal has an extremely low potential and a high theoretical capacity density, such lithium metal secondary batteries are expected, and the following lithium metal secondary battery is disclosed.

For example, Patent Document 1 discloses a lithium metal secondary battery comprising a solid electrolyte layer between a positive electrode and a negative electrode, the negative electrode comprising a negative electrode current collector and a protective layer, the protective layer comprising a metal capable of being alloyed with lithium, and having a volume capacity density of 1000 mAh/L or more. According to Patent Document 1, the durability of the lithium metal secondary battery can be improved.

Patent Document 2 discloses an all-solid-state lithium battery constituted by bonding a positive electrode, a solid electrolyte, and a negative electrode consisting of a metal lithium, on the surface between the solid electrolyte and the lithium negative electrode, and characterized by providing at least on type of lithium-aluminum alloys, lithium-indium alloys, lithium-antimony alloys, and lithium-bismuth alloys. According to the all-solid-state lithium battery of Patent Document 2, it is not necessary to comprise an extra mechanism to contact the solid phase interface between the solid electrolyte and Li metal negative electrode, simply by providing Li alloy layer to the boundary surface between the solid electrolyte and Li negative electrode, even in discharging due to a large current density of the battery, it is possible to maintain good contact at the boundary surface, since the further pressurization mechanism is not necessary, it is said that the size, weight, and thinning of the battery can be reduced.

### CITATION LIST

### Patent Literature

[PLT 1] Japanese Unexamined Patent Publication (Kokai) No. 2023-035226
[PLT 2] Japanese Examined Patent Publication (Kokoku) No. 6-101335

### SUMMARY

### Technical Problem

A lithium metal secondary battery containing lithium metal as a negative electrode active material is expected to have battery characteristics, but the cycle property thereof is not yet sufficient, and improvement of the cycle property is required. As one of the factors that the cycle property of the lithium metal secondary battery is not sufficient, it is considered that the interface between the electrolyte layer and the lithium metal layer is peeled off.

It is an object of the present disclosure to provide a lithium metal secondary battery capable of improving cycle property.

### Solution to Problem

The present disclosure achieves the above purpose.

### <Aspect 1>

A lithium metal secondary battery,

wherein the lithium metal secondary battery comprises a negative electrode current collector layer, an alloy layer, an electrolyte layer, a positive electrode active material layer, and a positive electrode current collector layer in this order, and

wherein the alloy layer comprises an alloy having indium and tin.

### <Aspect 2>

The lithium metal secondary battery according to aspect 1, further comprising a lithium metal layer between the negative electrode active material layer and the alloy layer.

### <Aspect 3>

The lithium metal secondary battery according to aspect 1 or 2, the mole ratio of the indium to the tin of the alloy having indium and tin is 30/70-70/30.

### <Aspect 4>

The lithium metal secondary battery according to any one of aspects 1 to 3, in the charged state of the lithium metal secondary battery, the thickness of alloy layer is 0.1 μm or more and 15 μm or less.

### <Aspect 5>

The lithium metal secondary battery according to any one of aspects 1 to 4, wherein the electrolyte layer comprises a solid electrolyte.

### Effects

According to the lithium metal secondary battery of the present disclosure, cycle property can be improved.

### BRIEF DESCRIPTION OF DRAWINGS

FIG. 1A is an image showing, for the lithium-metal secondary battery D2 of Example 2, the results of EDX mapping analysis by cross-sectional SEM-EDX after the first charge at 60° C. for an overlay of indium (In), tin (Sn), Fe (iron), sulfur(S), and oxygen (O).

FIG. 1B is an image showing, for the lithium-metal secondary battery D2 of Example 2, the results of EDX mapping analysis by cross-sectional SEM-EDX after the first charge at 60° C. for an overlay indium (In).

FIG. 1C is an image showing, for the lithium-metal secondary battery D2 of Example 2, the results of EDX mapping analysis by cross-sectional SEM-EDX after the first charge at 60° C. for an overlay of tin (Sn).

FIG. 1D is an image showing, for the lithium-metal secondary battery D2 of Example 2, the results of EDX mapping analysis by cross-sectional SEM-EDX after the first charge at 60° C. for an overlay of sulfur(S).

FIG. 1E is an image showing, for the lithium-metal secondary battery D2 of Example 2, the results of EDX mapping analysis by cross-sectional SEM-EDX after the first charge at 60° C. for an overlay of Fe (iron).

FIG. 1F is an image showing, for the lithium-metal secondary battery D2 of Example 2, the results of EDX mapping analysis by cross-sectional SEM-EDX after the first charge at 60° C. for an overlay of oxygen (O).

FIG. 2A is a cross-sectional SEM image showing, for the lithium-metal secondary battery D2 of Example 2, after the first charge at 60° C..

FIG. 2B is a schematic view of a cross-sectional structure showing, for the lithium-metal secondary battery D2 of Example 2, after the first charge at 60° C..

FIG. 3A is cross-sectional SEM image showing, for the lithium-metal secondary battery d1 of Comparative Example 1, after the first charge at 60° C..

FIG. 3B is schematic view of the cross-sectional structure showing, for the lithium-metal secondary battery d1 of Comparative Example 1, after the first charge at 60° C..

FIG. 4A is a cross-sectional SEM image showing, for the lithium-metal secondary battery d2 of Comparative Example 2, after the first charge at 60° C..

FIG. 4B is a schematic view of a cross-sectional structure, for the lithium-metal secondary battery d2 of Comparative Example 2, after the first charge at 60° C..

### DESCRIPTION OF EMBODIMENTS

Hereinafter, embodiments of the present disclosure will be described in detail. The present disclosure is not limited to the following embodiments, but can be implemented with various modifications within the scope of the gist of the present disclosure. Further, the same elements in the description of the drawings are denoted by the same reference numerals, and redundant description will be omitted.

With respect to the present disclosure, a “mixture” means a composition capable of constituting a positive electrode active material layer or an electrolyte layer as it is or by further containing other components. In addition, with respect to the present disclosure, a “mixture slurry” means a slurry which contains a dispersion medium in addition to a “mixture” and thereby can be applied and dried to form a positive electrode active material layer or an electrolyte layer.

The lithium metal secondary battery of the present disclosure may be a liquid-based battery containing a liquid electrolyte as an electrolyte layer, and may be a solid battery having a solid electrolyte layer as an electrolyte layer. Note that, with respect to the present disclosure, “solid battery” means a battery using at least a solid electrolyte as an electrolyte, and therefore, a solid battery may use a combination of a solid electrolyte and a liquid electrolyte as an electrolyte.

The lithium metal secondary battery of the present disclosure may be an all-solid-state battery, that is, a battery using only a solid electrolyte as an electrolyte.

### <<Lithium Metal Secondary Battery>>

The lithium metal secondary battery of the present disclosure comprises a negative electrode current collector layer, an alloy layer, an electrolyte layer, a positive electrode active material layer, and a positive electrode current collector layer in this order, and wherein the alloy layer contains an alloy having indium and tin.

According to the lithium metal secondary battery of the present disclosure, cycle property can be improved.

In the lithium metal secondary battery, although not particularly limited, during charging, lithium ions move from the positive electrode (positive electrode active material) to the negative electrode, and lithium metal is deposited on the negative electrode side to form a lithium metal layer. On the other hand, during discharge, the lithium metal layer on the negative electrode side dissolves, and lithium ions move from the negative electrode (lithium metal layer) to the positive electrode.

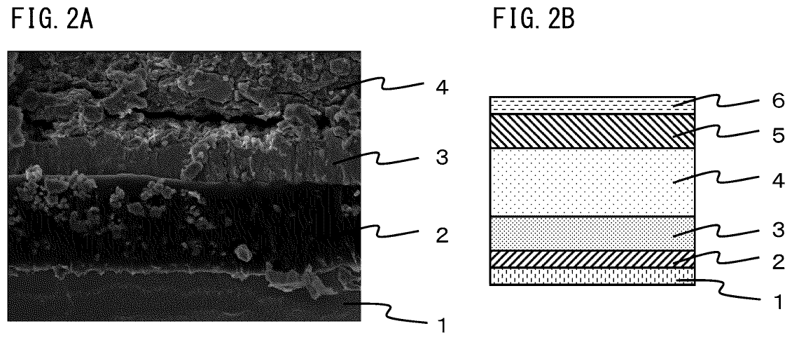

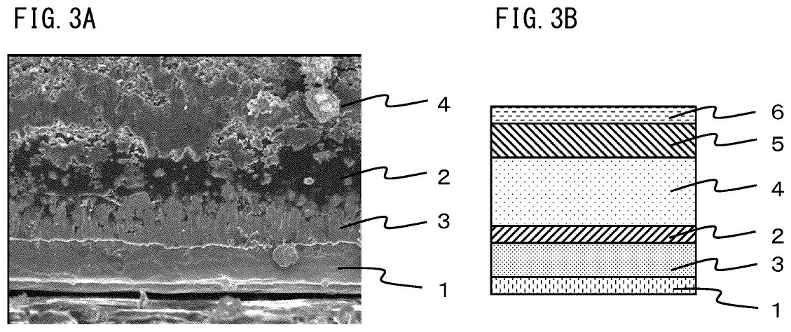

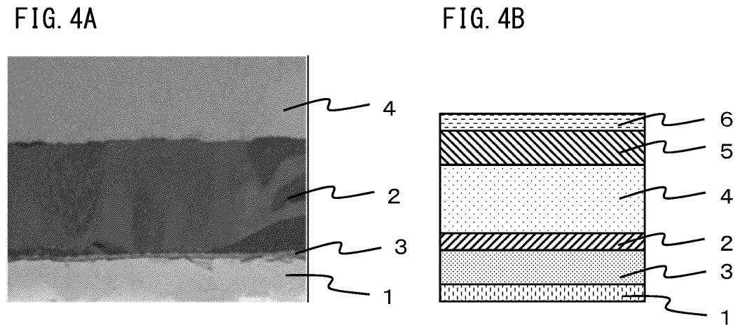

As shown in FIGS. 2A and 2B, in the lithium metal secondary battery of the present disclosure containing an alloy layer having indium and tin, after the first charging, the alloy layer 3 (lithium-indium-tin layer) in which lithium was inserted and the lithium metal layer 2 were formed in the order of the electrolyte layer 4, the alloy layer 3 (lithium-indium-tin layer) in which lithium was inserted, the lithium metal layer 2, and the negative electrode current collector layer 1. On the other hand, as shown in FIGS. 3A-3B and FIGS. 4A-4B, in the lithium metal secondary battery containing an alloy layer having only one of indium and tin, after the initial charge, the alloy layer 3 (lithium-indium layer or lithium-tin layer) in which lithium was inserted and the lithium metal layer 2 were formed in the order of the electrolyte layer 4, the lithium metal layer 2, the alloy layer 3 (lithium-indium layer or lithium-tin layer) in which lithium was inserted, and the negative electrode current collector layer 1.

The alloy layer of the present disclosure contains an alloy comprising indium and tin. When making an alloy layer containing indium and tin, it is believed that the alloy containing indium and tin has a plurality of indium-tin alloy phases.

From the above, it is presumed that the lithium metal secondary battery of the present disclosure is not particularly limited, but that a lithium metal layer is peculiarly deposited between the alloy layer and the negative electrode current collector layer during charging by a plurality of indium-tin alloy phases comprised in the alloy layer of indium and tin. Furthermore, since the lithium metal layer was specifically deposited between the alloy layer and the negative electrode current collector layer, at the time of discharge, the separation of the interface between the electrolyte layer and the alloy layer is suppressed, thereby, it is inferred that it was possible to improve the cycle property of the lithium metal secondary battery.

### <Configuration of Lithium Metal Secondary Battery>

The lithium metal secondary battery of the present disclosure has a negative electrode current collector layer, an alloy layer, an electrolyte layer, a positive electrode active material layer, and a positive electrode current collector layer in this order.

### <Negative Electrode Current Collector Layer>

The material used for the negative electrode current collector layer is not particularly limited, but any material that can be used as a negative electrode current collector of a battery can be appropriately adopted. For example, the negative electrode current collector layer includes, but are not limited to, stainless-steel (SUS), nickel, copper, copper alloys, and metal-plated, coated, or vapor-deposited nickel, chromium, carbon, and the like.

The shape of the negative electrode current collector layer is not particularly limited, and may be, for example, a foil shape, a plate shape, a mesh shape, or the like. In some embodiments, the shape of the negative electrode current collector layer is a foil shape.

### <Alloy Layer>

In the lithium metal secondary battery of the present disclosure, the alloy layer contains an alloy having indium and tin.

The molar ratio of the indium to the tin of the alloy having indium and tin (molar ratio of indium/tin) is not particularly limited, but may be 30/70 to 70/30. This molar ratio is not particularly limited, but may be 10/90 to 90/10, 20/80 to 80/20, 25/75 to 75/25, 30/70 to 70/30, 35/65 to 65/35, 40/60 to 60/40, or 45/55 to 55/45.

The alloy having indium and tin may further contain a metal other than indium, tin, and lithium. The molar ratio of indium and tin to the metal other than indium, tin, and lithium ((indium and tin)/(metal other than indium, tin, and lithium)) is not particularly limited, but may be 50/50 to 100/0, 60/40 to 100/0, 70/30 to 100/0, 80/20 to 100/0, 90/10 to 100/0, or 95/5 to 100/0.

The alloy containing indium and tin may further comprise lithium. The alloy containing indium and tin is not particularly limited, but may be accompanied by insertion and removal of lithium as the lithium metal secondary battery is charged and discharged.

In the charged state of the lithium metal secondary battery, the thickness of the alloy layer may be 0.1 μm or more 15 μm or less.

In the charged state of the lithium metal secondary battery, the thickness of the alloy layer is not particularly limited, but may be 0.01 μm or more, 0.1 μm or more, 0.2 μm or more, 0.4 μm or more, 0.6 μm or more, or 0.8 μm or more, and may be 100 μm or less, 50 μm or less, 40 μm or less, 30 μm or less, 20 μm or less, 15 μm or less, or 10 μm or less. The method for producing the alloy layer is not particularly limited, and can be

produced by, for example, binary vapor deposition by an ion plating method, but is not limited to this case.

### <Electrolyte Layer>

### <Electrolyte Layer-Solid Electrolyte Layer>

The lithium metal secondary battery of the present disclosure may be a solid battery, that is, may have a solid electrolyte layer as the electrolyte layer.

In addition to the solid electrolyte, the solid electrolyte layer may comprise a binder or the like if necessary.

(Solid electrolyte)

The material of the solid electrolyte is not particularly limited, and for example, the solid electrolyte may be a sulfide solid electrolyte, an oxide solid electrolyte, or a polymer electrolyte.

For example, the sulfide solid electrolyte includes, but are not limited to, a sulfide-based amorphous solid electrolyte, a sulfide-based crystalline solid electrolyte, or an argyrodite-type solid electrolyte. For example, the sulfide solid electrolyte includes, but are not limited to, Li₂S—P₂S₅ systems (Li₇P₃S₁₁, Li₃PS₄, Li₈P₂S₉, etc.), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, etc.), LiI—Li₂S—P₂O₅, LiI—Li₃PO₄—P₂S₅, Li₇₋ₓPS₆₋ₓClₓ, etc.

For example, the solid-state electrolyte includes, but are not limited to, Li₇La₃Zr₃O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, or Li₃₊ₓPO₄₋ₓNₓ(LiPON).

The sulfide solid electrolyte and the oxide solid electrolyte may be glass or crystallized glass (glass ceramic).

The polymer electrolyte includes, but are not limited to, polyethylene oxide (PEO), polypropylene oxide (PPO), and copolymers thereof.

### (Binder)

The binder is not particularly limited. For example, the binder may be, but is not limited to, a material such as polyvinylidene fluoride (PVdF), butadiene rubber (BR), polytetrafluoroethylene (PTFE) or styrene butadiene rubber (SBR), or a combination thereof.

The thickness of the electrolyte layer may be, for example, 0.1 to 1000 μm.

### <Electrolyte Layer-Liquid Electrolyte>

The lithium metal secondary battery of the present disclosure may be a liquid-based battery, that is, it may have a liquid electrolyte as an electrolyte layer, particularly an electrolytic solution held in a separator layer.

### (Electrolyte)

The electrolytic solution is not particularly limited, but, in some embodiments, contains a support salt and a solvent.

Supporting salt (lithium salt) of an electrolyte having lithium ion conduction includes, for example, an inorganic lithium salt such as LiPF₆, LiBF₄, LiClO₄, LiAsF₆, and an organolithium salt such as LiCF₃SO₃, LIN (CF₃SO₂)₂, LIN(C₂F₅SO₂)₂, LiN(FSO₂)₂, LiC(CF₃SO₂)₃.

For example, the solvent used in the electrolytic solution includes cyclic esters (cyclic carbonates) such as ethylene carbonate (EC), propylene carbonate (PC), and butylene carbonate (BC), and chain esters (chain carbonates) such as dimethyl carbonate (DMC), diethyl carbonate (DEC), and ethyl methyl carbonate (EMC)

In some embodiments, the electrolytic solution contains 2 or more kinds of solvents.

### (Separator)

The battery of the present disclosure may further comprise a separator. The separator is not particularly limited, and for example, a nonwoven fabric such as a polyolefin type, a polyamide type, or a polyimide type can be used.

### <Positive Electrode Active Material Layer>

The positive electrode active material layer comprises a positive electrode active material, and may comprise a binder, a conductive agent, and a solid electrolyte if necessary.

### (Positive Electrode Active Material)

The material of the positive electrode active material is not particularly limited. For example, the positive electrode active material may be, but is not limited to, lithium cobalt oxide (LiCoO₂), lithium nickel oxide (LiNiO₂), lithium manganese oxide (LiMn₂O₄), lithium nickel cobalt manganese oxide (NCM), LiCO_{1/3}Ni_{1/3}Mn_{1/3}O₂, lithium nickel cobalt aluminum oxide (NCA; LiNiₓCo_{y}Al_{z}O₂) and a heterogeneous element-substituted Li—Mn spinel represented by, Li₁₊ₓMn_{2-x-y}M_{y}O₄ (M is one or more metallic elements selected from Al, Mg, Co, Fe, Ni, and Zn).

The positive electrode active material may have a coating layer. The coating layer is a layer containing a substance which has lithium-ion conductivity, has low reactivity with a positive electrode active material or a solid electrolyte, and can maintain a form of a coating layer which does not flow even when in contact with an active material or a solid electrolyte. Exemplary components of the covering layers include, but are not limited to, LiNbO₃ and Li₄Ti₅O₁₂, or Li₃PO₄.

The shape of the positive electrode active material may comprise particulate, for example.

The average particle diameter (D₅₀) of the positive electrode active material is not particularly limited, but may be, for example, 10 nm or more, or 100 nm or more. On the other hand, the average particle diameter (D₅₀) of the positive electrode active material may be, for example, 50 μm or less, or 20 μm or less. The average particle size (D₅₀), for example, can be calculated from the measured by laser diffractometer particle size distribution, a scanning-electron-microscope (SEM).

The thickness of the positive electrode active material layer may be, for example, 0.1 μm to 1000 μm.

### (Conductive Agent)

The conductive agent is not particularly limited. For example, the conductive agent may be, but is not limited to, VGCF (Vapor Grown Carbon Fiber), acetylene black (AB), ketjen black (KB), carbon nanotube (CNT), carbon nanofiber (CNF), and the like.

For the binder and the solid electrolyte, reference can be made to the description of “Electrolyte layer” described above.

### <Positive Electrode Current Collector Layer>

The material used for the positive electrode current collector layer is not particularly limited, but any material that can be used as a positive electrode current collector of a battery can be appropriately adopted. For example, but not limited to, aluminum, SUS, chromium, gold, platinum, iron, titanium, zinc, and the like, and nickel, chromium, carbon, and the like plated, coated, or vapor deposited on these metals may be used.

The shape of the positive electrode current collector layer is not particularly limited, and may be, for example, a foil shape, a plate shape, a mesh shape, or the like. In some embodiments, the shape of the positive electrode current collector layer is a foil shape.

### <Lithium Metal Layer>

The lithium metal secondary battery of the present disclosure may further comprise a lithium metal layer between the negative electrode active material layer and the alloy layer.

The lithium metal secondary battery is not particularly limited, but during charging, lithium ions move from the positive electrode (positive electrode active material) to the negative electrode, and lithium metal is deposited on the negative electrode side to form a lithium metal layer. On the other hand, during discharge, the lithium metal layer on the negative electrode side dissolves, and lithium ions move from the negative electrode (lithium metal layer) to the positive electrode. Therefore, the lithium metal secondary battery may have the lithium metal layer in the charged state, and may not have the lithium metal layer in the initial state (before charging) or the discharged state, but is not limited to this case.

Although the lithium metal secondary battery of the present disclosure is not particularly limited, a lithium metal layer in which lithium metal is precipitated may be formed between the negative electrode active material layer and the alloy layer in a charged state.

The shape of the lithium-ion battery, for example, coin-type, laminate-type (pouch), cylindrical, square-type.

### EXAMPLES

The present disclosure will be described in more detail with reference to the following examples, but the scope of the present disclosure is not limited to these examples.

### Example 1

### <Preparation of an Alloy Layer A1>

In the binary deposition by the ion plating method, an alloy layer of indium and tin was deposited so as to have a thickness of 1.0 μm on a stainless-steel (SUS) foil as a negative electrode current collector, and an alloy layer A1 formed on SUS foil was obtained. At this time, the molar ratio of indium to tin was adjusted to be indium/tin=67/33. The molar of indium to tin in the obtained alloy-layer A1 was indium/tin=62/38.

<Preparation of an electrolyte layer B1>

A sulfide solid electrolyte (92.6 parts by mass), a binder (7.4 parts by mass), and an appropriate amount of butyl butyrate as a dispersion medium were mixed to adjust an electrolyte mixture slurry. The obtained electrolyte mixture slurry was coated on a release film with a coating gap of 325 μm. Then, it was pre-dried at room temperature for 3 hours, main dried for 1 hours at 165 Celsius degrees, and punched two sheets of coated foil on the main dried release film at q 14.50 mm. Then, the coated surfaces of coated foil were superposed each other and pressed at 7.0 ton, and the release films were peeled off to obtain a self-supporting electrolyte B1.

### Preparation of a Positive Electrode Active Material Layer C1

A nickel-cobalt-lithium aluminate (NCA) (84.7 parts by mass) as a positive electrode active material, a solid electrolyte (13.4 parts by mass), a binder (0.6 parts by mass), a conductive agent (1.3 parts by mass), and an appropriate amount of butyl butyrate as a dispersion medium were mixed to adjust a positive electrode mixture slurry. The resulting positive electrode mixture slurry was coated on an aluminum (A1) foil as a positive electrode current collector with a coating gap-225 μm, pre-dried at 60° C., and main dried for 1 hour at 165 Celsius degrees, to obtain a positive electrode active material layers C1 formed on A1 foil. The loading of the positive electrode active material layers C1 was 18.7 mg/cm², and the design capacity of the positive electrode active material layers C1 was 3.0 mAh/cm².

### <Preparation of a Lithium Metal Secondary Battery D1>

The alloy layer A1 was punched out with a diameter of 14.50 mm and the positive electrode active material layer C1 was punched out with a diameter of 11.28 mm.
The solid-state electrolyte layer B1 was disposed between the alloy layer A1 and the positive electrode active material layer C1, and laminated so as to be a negative electrode current collector layer, an alloy layer, an electrolyte layer, a positive electrode active material layer, and a positive electrode current collector layer in this order.
Then, the laminate is covered with a laminated film, vacuum-sealed, and isotropically pressed with a 392 MPa by cold isotropic pressing to obtain a lithium-metal secondary battery D1. Here, aluminum (A1) was used for the positive electrode tab, and nickel (Ni) was used for the negative electrode tab.

### <Electrochemical Measurement of the Lithium Metal Secondary Battery D1>

The lithium-metal secondary battery D1 was confined to 1 MPa with a pressure fixture with a spring inserted so that the confining pressure was constant. Next, the lithium-metal secondary battery D1 was placed in a constant temperature bath at 60° C., and a constant current (current density: corresponding to 0.15 mA/cm², 0.05C)-constant voltage (cut-off current density: corresponding to 0.03 mA/cm², 0.01C) test was performed at 60° C. within the cutoff voltage 4.2V-3.0V. Next, the lithium-metal secondary battery D1 was transferred to a thermostatic chamber at 25° C., and a constant current (current density: corresponding to 0.15 mA/cm², 0.05C)-constant voltage (cut-off current density: corresponding to 0.03 mA/cm², 0.01C) test was performed at 25 Celsius degree within the cutoff voltage 4.2V-3.0V, and the cycling property of the reversible-capacity was evaluated. The reversible capacity of lithium metal secondary battery D1 showed 1.48 mAh/cm² after 20 cycles.

### Example 2

### Preparation of an Alloy Layer A2

An alloy layer A2 formed on a SUS foil was obtained by the same method as in “Preparation of an alloy layer A1” in Example 1, except that the molar ratio of indium to tin was adjusted to be indium/tin=50/50. The molar ratio of indium to tin of the obtained alloy layer A2 was indium/tin=49/51.

### Preparation and Electrochemical Measurement of a Lithium Metal Secondary Battery D2

A lithium metal secondary battery D2 was obtained in the same method as in “Preparation of a lithium metal secondary battery D1” in Example 1, except that the alloy layer A2 was used instead of the alloy layer A1. The electrochemical measurement of the lithium metal secondary battery D2 was performed in the same method as in “Electrochemical measurement of the lithium metal secondary battery D1” in Example 1. The reversible capacity of lithium metal secondary battery D2 showed 1.44 mAh/cm² after 20 cycles.

### <Observing SEM-EDX of Lithium Metal Secondary Battery D2>

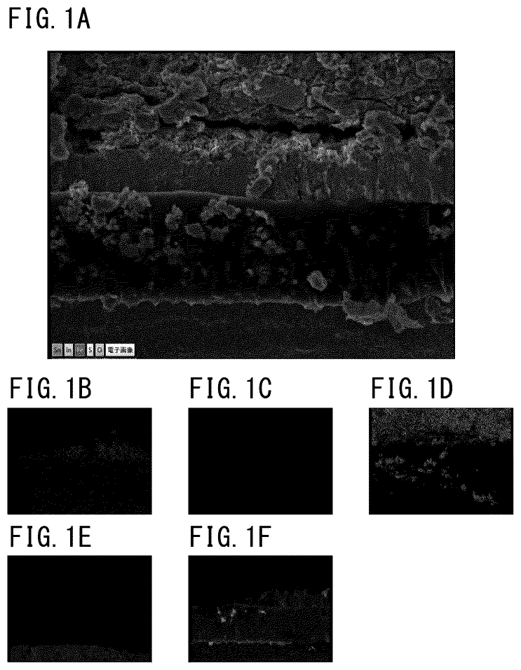

Cross sections of lithium-metal secondary battery D2 after initial charge at 60 Celsius degrees were observed by scanning electron microscopy (SEM) in secondary electron images 5 kV applied voltage, and elemental mapping by energy-dispersive X-ray spectroscopy (EDX). FIG. 1 shows the results of EDX mapping-analysis of the lithium metal secondary battery D2, and FIG. 2 shows a schematic view of a cross-sectional SEM image and a cross-sectional structure of a lithium metal secondary battery D2. From SEM-EDX observations, the lithium metal secondary battery D2 confirmed that, after the first charge, the electrolyte layer 4, the alloy layer 3 (lithium-indium-tin layer) in which lithium is inserted, the lithium metal layer 2, and the negative electrode current collector layer 1 are laminated in this order.

### Example 3

### Preparation of an Alloy Layer A3

An alloy layer A3 formed on a SUS foil was obtained by the same method as in “Preparation of an alloy layer A1” in Example 1, except that the molar ratio of indium to tin was adjusted to be indium/tin=33/67. The molar ratio of indium to tin of the obtained the alloy layer A3 was indium/tin=38/62.

### Preparation and Electrochemical Measurement of a Lithium Metal Secondary Battery D3

A lithium metal secondary battery D3 was obtained in the same method as in “Preparation of a lithium metal secondary battery D1” in Example 1, except that the alloy layer A3 was used instead of the alloy layer A1. The electrochemical measurement of the lithium metal secondary battery D3 was performed in the same method as in “Electrochemical measurement of the lithium metal secondary battery D1” in Example 1. The reversible capacity of lithium metal secondary battery D3 showed 1.40 mAh/cm² after 20 cycles.

### Comparative Example 1

### Preparation of an Alloy Layer a1

An alloy layer a1 formed on a SUS foil was obtained by the same method as in “Preparation of an alloy layer A1” in Example 1 except that only Indium was used. The molar ratio of indium to tin of the obtained alloy layer a1 was indium/tin=100/0.

### Preparation, Electrochemical Measurement, and SEM-EDX Observation of a Lithium Metal Secondary Battery d1

A lithium metal secondary battery d1 was obtained in the same method as in “Preparation of lithium metal secondary battery D1” in Example 1, except that the alloy layer a1 was used instead of the alloy layer A1. The electrochemical measurement of the lithium metal secondary battery d1 was performed in the same method as in “Electrochemical measurement of lithium metal secondary battery D1” in Example 1. The reversible capacity of lithium metal secondary battery d1 showed 1.26 mAh/cm² after 20 cycles. SEM-EDX observation of the lithium metal secondary battery d1 was performed by “Observing SEM-EDX of the lithium metal secondary battery D2” in Example 2. FIG. 3 shows a cross-sectional SEM image and a cross-sectional view of a lithium-metal secondary battery d1. From SEM-EDX observations, it was confirmed that the lithium metal secondary battery d1, after the first charge, the electrolyte layer 4, the lithium metal layer 2, the alloy layer 3 (lithium-indium layer) in which lithium is inserted, and the negative electrode current collector layer 1 are formed in this order.

### Comparative Example 2

### Preparation of an Alloy Layer a2

An alloy layer a2 formed on a SUS foil was obtained by the same method as in “Preparation of an alloy layer A1” in Example 1 except that only tin was used. The molar ratio of indium to tin of the obtained mixture layer a2 was indium/tin=0/100.

### Preparation, Electrochemical Measurement, and SEM-EDX Observation of a Lithium Metal Secondary Battery d2

A lithium metal secondary battery d2 was obtained in the same method as in “Preparation of a lithium metal secondary battery D1” in Example 1, except that the alloy layer a2 was used instead of the alloy layer A1. The electrochemical measurement of the lithium metal secondary battery d2 was performed in the same method as in “Electrochemical measurement of the lithium metal secondary battery D1” in Example 1. The reversible capacity of lithium metal secondary battery d2 showed 0.80 mAh/cm² after 20 cycles. SEM-EDX observation of the lithium metal secondary battery d2 was performed by “Observing SEM-EDX of the lithium metal secondary battery D2” in Example 2. FIG. 4 shows a cross-sectional SEM image and a cross-sectional view of a lithium-metal secondary battery d2. From SEM-EDX observations, it was confirmed that the lithium metal secondary battery d2, after the first charge, the electrolyte layer 4, the lithium metal layer 2, the alloy layer 3 (lithium-tin layer) in which lithium is inserted, and the negative electrode current collector layer 1 are formed in this order.

Table 1 shows the results of electrochemical measurements of the lithium metal secondary batteries of examples 1 to 3 and comparative examples 1 and 2.

TABLE 1

| | | | | | Comparative | Comparative |
|---|---|---|---|---|---|---|
| | | Example 1 | Example 2 | Example 3 | Example 1 | Example 2 |
| Alloy layer | | Alloy layer A1 | Alloy layer A2 | Alloy layer A3 | Alloy layer a1 | Alloy layer a2 |
| Mole ratio | Indium/Tin | 62/38 | 49/51 | 38/62 | 100/0 | 0/100 |
| | [mol %] | | | | | |
| Electrolyte layer | | Electrolyte | Electrolyte | Electrolyte | Electrolyte | Electrolyte |
| | | layer B1 | layer B1 | layer B1 | layer B1 | layer B1 |
| Electrolyte | Sulfide solid electrode | 92.6 | 92.6 | 92.6 | 92.6 | 92.6 |
| mixture | [parts by mass] | | | | | |
| | Binder | 7.4 | 7.4 | 7.4 | 7.4 | 7.4 |
| | [parts by mass] | | | | | |
| Positive electrode | | Positive electrode | Positive electrode | Positive electrode | Positive electrode | Positive electrode |
| active material layer | | active material | active material | active material | active material | active material |
| | | layer C1 | layer C1 | layer C1 | layer C1 | layer C1 |
| Positive | Positive electrode | 84.7 | 84.7 | 84.7 | 84.7 | 84.7 |
| electrode | active material:NCA | | | | | |
| mixture | [parts by mass] | | | | | |
| | Solid Electrolyte | 13.4 | 13.4 | 13.4 | 13.4 | 13.4 |
| | [parts by mass] | | | | | |
| | Binder | 0.6 | 0.6 | 0.6 | 0.6 | 0.6 |
| | [parts by mass] | | | | | |
| | Conductive agent | 1.3 | 1.3 | 1.3 | 1.3 | 1.3 |
| | [parts by mass] | | | | | |
| Lithium metal | | Lithium metal | Lithium metal | Lithium metal | Lithium metal | Lithium metal |
| secondary battery | | secondary | secondary | secondary | secondary | secondary |
| | | battery D1 | battery D2 | battery D3 | battery d1 | battery d2 |
| Evaluation | Reversible capacity | 1.48 | 1.44 | 1.40 | 1.26 | 0.80 |
| results | arter 20 cycles | | | | | |
| | [mAh/cm²] | | | | | |

Regarding the reversible capacity after 20 cycles, the lithium metal secondary battery D1-D3 showed higher values compared with the lithium metal secondary battery d1 and d2. That is, by using the alloy layers containing indium and tin, it was possible to improve the cycle property of the lithium-metal secondary battery D1-D3.

In the lithium metal secondary battery D2 comprising the alloy layer A2, after the first charge, the alloy layer 3 (lithium-indium-tin layer) in which lithium was inserted and the lithium metal layer 2 were formed in the order of the electrolyte layer 4, the alloy layer 3 (lithium-indium-tin layer) in which lithium was inserted, the lithium metal layer 2, and the negative electrode current collector layer 1. On the other hand, in the lithium metal secondary battery d1 comprising the alloy layer a1 or the lithium metal secondary battery d2 comprising the alloy layer a2, after the first charge, the alloy layer 3 (lithium-indium layer or lithium-tin layer) in which lithium is inserted and the lithium metal layer 2 were formed in the order of the electrolyte layer 4, the lithium metal layer 2, the alloy layer 3 (lithium-indium layer or lithium-tin layer) in which lithium is inserted, and the negative electrode current collector layer 1.

When preparing an alloy layer containing indium and tin, it is considered that there is a plurality of indium-tin alloy phases.

From the above, it is presumed that in the lithium metal secondary battery of the present disclosure, the lithium metal layer was peculiarly deposited between the alloy layer and the negative electrode current collector layer during charging by a plurality of indium-tin alloy phases comprised in the alloy layer of indium and tin. Furthermore, since the lithium metal layer was specifically deposited between the alloy layer and the negative electrode current collector layer, at the time of discharge, the separation of the interface between the electrolyte layer and the alloy layer is suppressed, thereby, it is inferred that it was possible to improve the cycle characteristics of the lithium metal secondary battery.

While an embodiment of a lithium metal secondary battery of the present disclosure has been described, those skilled in the art will appreciate that changes can be made without departing from the scope of the claims.

### REFERENCE SIGNS LIST

1 Negative current collector layer
2 Lithium metal layer
3 Alloy layer inserted lithium
4 Electrolyte layer
5 Positive electrode active material layer
6 Positive current collector layer

1. A lithium metal secondary battery,
wherein the lithium metal secondary battery comprises a negative electrode current collector layer, an alloy layer, an electrolyte layer, a positive electrode active material layer, and a positive electrode current collector layer in this order, and
wherein the alloy layer comprises an alloy having indium and tin.

2. The lithium metal secondary battery according to claim 1, further comprising a lithium metal layer between the negative electrode active material layer and the alloy layer.

3. The lithium metal secondary battery according to claim 1, the mole ratio of the indium to the tin of the alloy having indium and tin is 30/70-70/30.

4. The lithium metal secondary battery according to claim 1, in the charged state of the lithium metal secondary battery, the thickness of alloy layer is 0.1 μm or more and 15 μm or less.

5. The lithium metal secondary battery according to claim 1, wherein the electrolyte layer comprises a solid electrolyte.
